(19) United States
(12) Patent Application Publication
(10) Pub. No.: US 2014/0176417 A1
(43) Pub. Date: Jun. 26, 2014

(54) WEARABLE PROJECTOR FOR PORTABLE DISPLAY

(71) Applicants: Ian A. Young, Portland, OR (US); Johanna M. Swan, Scottsdale, AZ (US); Robert L. Sankman, Phoenix, AZ (US); Marko Radosavljevic, Beaverton, OR (US)

(72) Inventors: Ian A. Young, Portland, OR (US); Johanna M. Swan, Scottsdale, AZ (US); Robert L. Sankman, Phoenix, AZ (US); Marko Radosavljevic, Beaverton, OR (US)

(21) Appl. No.: 13/724,741

(22) Filed: Dec. 21, 2012

(51) Int. Cl. G09G 5/12

(52) U.S. Cl. CPC G09G 5/12
USPC 345/156

(57) ABSTRACT

Described herein are technologies related to a wearable projector to project images, information, multimedia, etc. in a portable display. More particularly, the wearable projector includes a system on chip (SOC) microprocessor that is configured to project the images, information, multimedia, etc. to different types of portable display such as, flexible transparent plastic, glass, paper, and the like.

### BACKGROUND

The use of information and communications technology devices has become ubiquitous since the advent of wireless devices such as, smart phones and portable computers (i.e., netbooks, Ultrabooks, etc.). However, all of these devices use active displays that may consume more power than any other component in the device. Active displays combined with generation of sounds when playing a movie in a wireless device may easily drain a battery.

A conventional projector apparatus displays an image on a fixed projection screen. For example, the conventional projector apparatus creates the image by shining a light through a small transparent image. In this example, the light is reflected on the projection screen for viewing of a user. Consequently, this conventional projector apparatus is not always easy to carry and to install. For example, the fixed projection screen may limit viewing area for the user.

### BRIEF DESCRIPTION OF THE DRAWINGS

FIG. 1 illustrates an example scenario that shows different situations of utilizing a wearable projector to display images, information, multimedia, etc. in a portable display.

FIG. 2 illustrates an example interaction between a wearable projector and a portable display.

FIG. 3 illustrates an example system showing component blocks of a wearable projector.

FIG. 4 illustrates an example system of a wireless device that establishes wire/wireless communications with a wearable projector.

FIG. 5 illustrates an example flowchart of an example method of implementing wearable projector.

### DETAILED DESCRIPTION

Described herein is a technology for a wearable projector that projects images to a passive portable display as an alternative to active displays in wireless devices. More particularly, a method of displaying images, information, multimedia, and the like, in the portable display using the wearable projector or imaging system is described

As an example of current implementation herein, the (passive) portable display includes, but is not limited to, a screen of the wireless device, a flexible transparent plastic or glass, a piece of paper, or a plastic flexible portable display with an array of concave dimples to allow multi-viewers. In this example, the portable display is independently linked with the wearable projector that is configured to project the information, multimedia, and the like, to the portable display.

In an implementation, the wearable projector may contain a system on chip (SOC) microprocessor that is configured to receive data through a network or radio signal. Furthermore, the SOC microprocessor is configured to process and control operations of the wearable projector in displaying the information, multimedia, and the like, through the portable display. For example, the wearable projector detects a display size of the portable display. In this example, the SOC microprocessor is configured to adjust focus of projection within the detected display size of the portable display. In another example, the wearable projector detects a user's finger pointing to current image in the portable display. In this example, the SOC microprocessor may be configured to stop/pause operation of the wearable projector, or focus the projection at the direction of the user's finger.

In an implementation, the wearable projector is configured to include photovoltaic cells for power generation and a transceiver system for wireless communications. In this implementation, the wearable projector is built in a flexible and/or sticky housing that may be attached to a skin of the user. For example, the user installs the wearable projector at his forehead to direct the projection of the multimedia from his wireless device to a passive wall surface in front of the user. In another example, the projection is configured to adapt changes in the size of the cellulose paper where the information, multimedia, etc. is currently displayed.

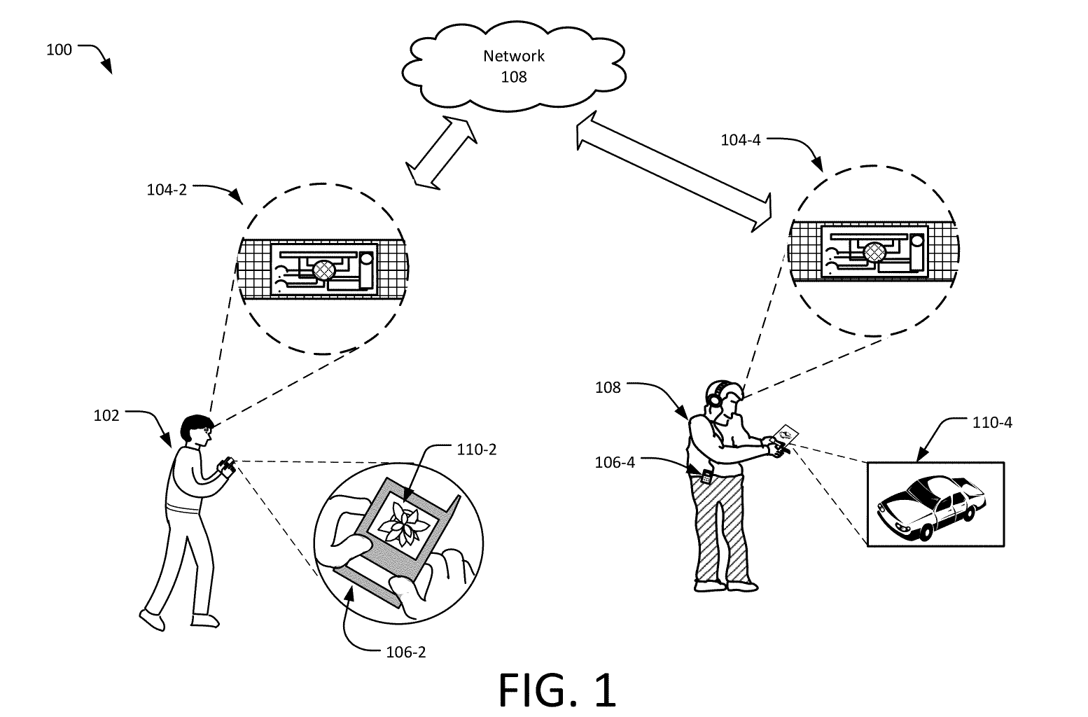

FIG. 1 illustrates a scenario 100 that shows different situations of utilizing a wearable projector to display images, information, multimedia, etc. to a portable display. As shown, scenario 100 depicts a teenager 102 with an attached wearable projector 104-2 in his forehead while holding a wireless device 106-2, and an adult person 108 with an attached wearable projector 104-4 in his forehead and a wireless device 106-4 in his belt. Furthermore, scenario 100 shows a network 108 that is utilized to establish wireless communications, and portable displays 110-2 and 110-4 that are used to display the images, information, multimedia, and the like.

Scenario 100 depicts an example implementation of technology described herein. For example, the teenager 102 configures the wearable projector 104-2 to receive a message (e.g., picture of a flower) addressed to the wireless device 106-2 and displays the received message in the portable display 110-2. In this example, the portable display 110-2 is a touchscreen display of the wireless device 106-2 that passively displays the received message (i.e., picture of the flower) through the wearable projector 104-2. Furthermore, the wearable projector 104-2 may be configured to detect the size of the touchscreen display of the portable display 110-2 and/or to detect interactions such as pointing of a finger by the teenager 102 to the picture of the flower.

As an example of present implementation herein, the wearable projector 104-2 contains a SOC microcontroller chip that is configured to wirelessly communicate with the wireless device 106-2 and/or to another wireless device 106-4 through the network 108 or other radio signals such as, a cellular signal, a wireless fidelity (Wi-Fi) signal, a Bluetooth™ signal, or a near field communications (NFC) signal. For example, the wearable projector 104-2 projects the images (not shown) that the wireless device 106-4 is transmitting to the wireless device 106-2. In this example, the wearable projector 104-2 saves power consumption in the wireless device 106-2 by displaying the images in the portable display 110-2. In this example, the portable display 110-2 may include, but is not limited to, any surfaces such as the glass screen of the wireless device 106-2, paper, a wall, a laptop screen, a desktop screen, a window, a door, and the like.

As an example of present implementation herein, the adult person 108 may configure the wearable projector 104-4 to project a movie (e.g., currently running in his wireless device 106-4) to the portable display 110-4 (e.g., bond paper). For example, the wireless device 106-4 is configured to stream the movie to the wearable projector 104-4 through its Bluetooth™ features. In this example, the adult person 108 utilizes the bond paper as a display screen for viewing the movie. In another example, the portable display 110-4 may be configured to include a cellulose paper with an array of concave dimples (not shown) to enable another person (not shown) to view the streamed movie in a different angle from the adult person 108.

As depicted, the wireless device 106 may include, but is not limited to, a mobile phone, a cellular phone, a smartphone, a personal digital assistant, a tablet computer, a netbook, a notebook computer, a laptop computer, a multimedia playback device, a digital music player, a digital video player, a navigational device, a digital camera, and the like.

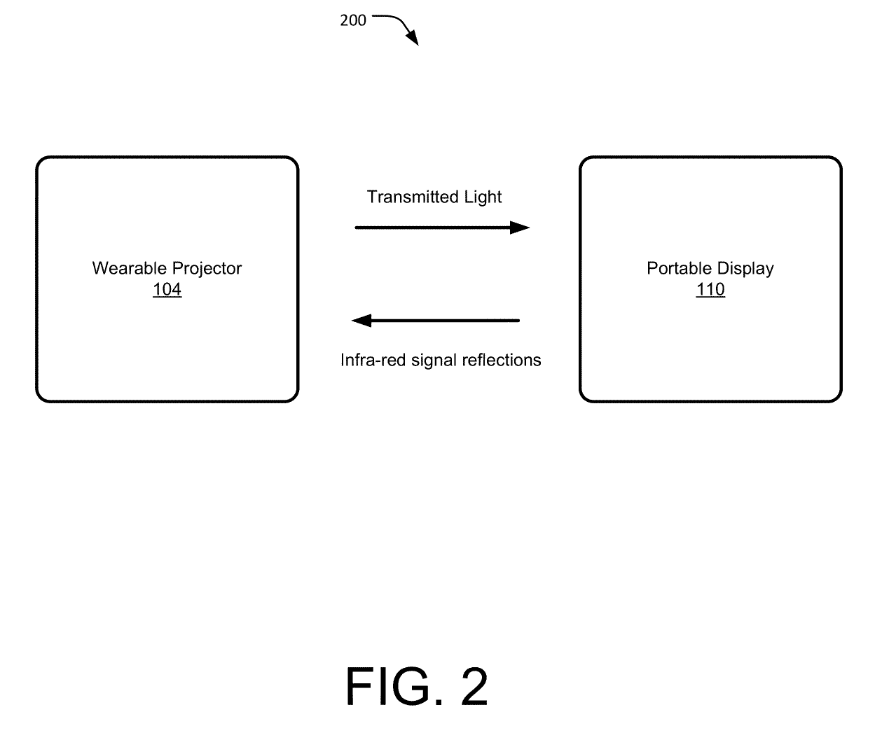

FIG. 2 depicts an example interaction 200 between the wearable projector 104 and the portable display 110.

As an example of present implementation herein, the portable display 110 is a flexible transparent passive display that acts as a handy and movable projection screen such as, a colored glass, transparent and/or flexible plastic or glass, a piece of paper, a wall surface, a table surface, or any reflecting flat or curved surfaces. For example, where the portable display 110 is a piece of bond paper, the wearable projector 104 is configured to detect bond paper size and more particularly, outside perimeter of the piece of bond paper so that any projected images, information, multimedia, etc. will not be displayed beyond this size or perimeter. In this example, the wearable projector 104 projects light representations of the images, information, multimedia, etc. Furthermore, the wearable projector 104 may detect a finger that points to the displayed images, information, multimedia, etc. in the portable display 110 in order to extend user experience and bring it closer to natural human habits and interactions.

As an example of present implementation herein, the detection by the wearable projector 104 of an interruption or the interaction (e.g., pointing of finger) with the displayed images, information, multimedia, etc. may include use of an image sensor (not shown). For example, the wearable projector 104 is configured to generate an infra-red signal that bounces back when interrupted by the pointing of the user's finger. In this example, the wearable projector 104 is configured to translate the interruption into another operation such as adjustment of the projection light by the wearable projector 104 or to totally stop/pause operation of the wearable projector 104.

Typically, the adjustment of the projection light corresponds to a folding crease of the portable display 110. For example, the bond paper as the portable display 110 is folded at the middle. In this example, the image sensor detects this crease and the wearable projector 104 adjusts its projection light to correspond with the size of the folded bond paper.

As an example of present implementation herein, the wearable projector 104 may be built in a thin and flexible housing so that components within the wearable projector 104 may not be damaged when bended. For example, the thin and flexible housing is a bandage patch of about an inch or two inches in size that contains a skin adhesive hydrogels to attach the housing to any body parts of a user. In another example, the wearable projector 104 is attached to an eyeglass of the user such as the teenager 102. In this example, multiple wearable projectors 104 may be configured to project the images, multimedia, etc. in 3D fashion or to provide dual image sensors parallaxing.

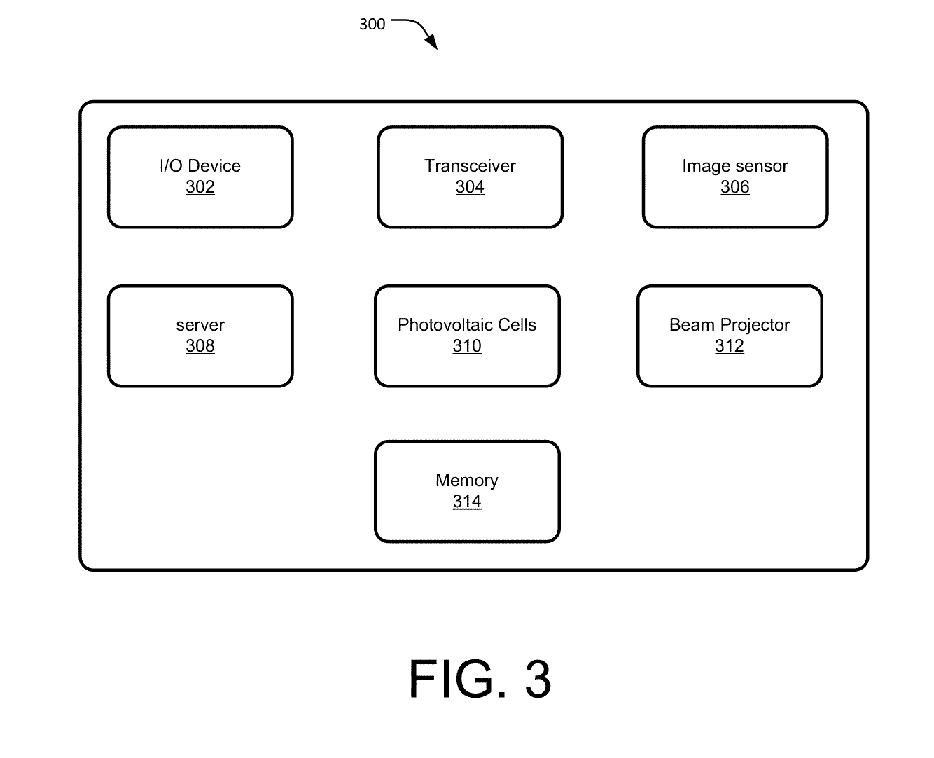

FIG. 3 illustrates an example system 300 that shows component blocks of the wearable projector 104. For example, the component blocks may include an input-output (I/O) component 302, a transceiver component 304, an image sensor 306, an personal server or server 308, photovoltaic cells 310, beam projector 312, and memory component 314. Other component blocks may be added herein without affecting current implementations as described. For example, solar cells or inductor power may be added to the photovoltaic cells 310 as a back-up power generator when the wearable projector 104 is powered OFF. In this example, the lack of solar cells or inductor power in system 300 does not affect the current implementations described herein.

As an example of present implementation herein, the I/O component 302 typically provides wired entry or exit of information from the system 300. For example, the I/O component 302 receives signals coming from input peripherals (e.g., keyboard) or integrated units that are connected to the system 300. In another example, the I/O component 302 provides processed information from the system 300 to output devices such as a microphone.

As an example of present implementation herein, the transceiver component 304 may establish wireless communications with the wireless device 106 or to link with the Internet. The wireless communications may utilize radio signals such as the cellular signal, wireless fidelity (Wi-Fi) signal, Bluetooth™ signal, or NFC signal. For example, the wireless device 106 streams a movie through its Bluetooth™ feature. In this example, the transceiver component 304 may receive the streamed movie using a frequency of the Bluetooth™ signal.

As an example of present implementation herein, the server 308 is configured to perform all computations, initiate wire/wireless communications, and/or to control operations in the wearable projector 104. For example, the server 308 is a SOC microprocessor that is configured to implement software program installed by the user or pre-installed for image projection purposes. For example, the software program includes detection of a display size of the portable display 110 through the image sensor 306. In this example, the server 308 performs a configured specific operation based upon the detected display size of the portable display 110. For example, the configured specific operation is an automatic adjustment of image projection to the portable display 110.

In another example, the server 308 performs a configured specific operation based upon a detected interruption such as pointing of a finger on a projected image by the user. In this example, the image sensor 306 may utilize infra-red signal reflections that are created by the pointing of the finger or any other physical movements within the detected display size of the portable display 110.

As an example of present implementation herein, the beam projector 312 typically refers to a component for projecting an image on the portable display 110. For example, the beam projector 312 transmits a light generated from an additional light source (e.g., laser light source) in order to project an image at a screen or the portable display 110. In this example, the focus of the generated light may be adjusted through the iServer 308 based upon the detections made in the image sensor 306. For example, the detections involve, but not limited to, a distance of the wearable projector 104 from the portable display 110, folding of the display size of the portable display 110, physical movements within the detected display size of the portable display 110, and the like.

As an example of current implementations herein, the image sensor 306 generates infra-red signals within the detected display size of the portable display 110 and communicates to the server 308 information with regard to any infra-red signal reflections. In this example, the server 308 is configured to perform the operation that corresponds to the communicated information. In another example, the information is stored in the memory 314 of the system 300. In this example, the memory 314 is coupled to the server 308.

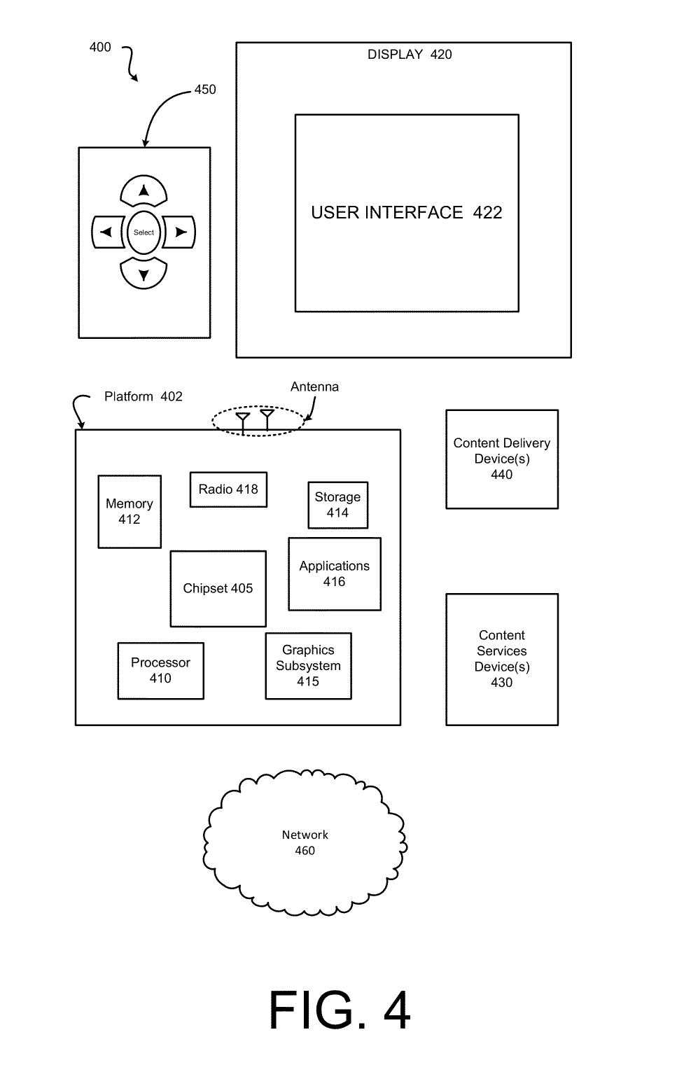

FIG. 4 illustrates an example system 400 of the wireless device 106 in accordance with present disclosure. In various implementations, system 400 may be a media system although system 400 is not limited to this context. For example, system 400 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 400 includes a platform 402 coupled to a display 420. Platform 402 may receive content from a content device such as content services device(s) 430 or content delivery device(s) 440 or other similar content sources. A navigation controller 450 including one or more navigation features may be used to interact with, for example, platform 402 and/or display 420. Each of these components is described in greater detail below.

In various implementations, platform 402 may include any combination of a chipset 405, processor 410, memory 412, storage 414, graphics subsystem 415, applications 416 and/or radio 418. Chipset 405 may provide intercommunication among processor 410, memory 412, storage 414, graphics subsystem 415, applications 416 and/or radio 418. For example, chipset 405 may include a storage adapter (not depicted) capable of providing intercommunication with storage 414.

Processor 410 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 410 may be dual-core processor(s), dual-core mobile processor(s), and so forth that is coupled to the PIC as discussed in FIG. 2 above.

As an example of current implementations herein, the processor 410 is configured to establish wire/wireless communications with the wearable projector 104. For example, the processor 410 is configured to include a software program that utilizes the wearable projector 104 to display images, multimedia, and the like, that are received by the wireless device 106. In this example, the processor 410 provides power efficiency to the wireless device 106.

Memory 412 may be implemented as a volatile memory device such as, but not limited to, a Random Access Memory (RAM), Dynamic Random Access Memory (DRAM), or Static RAM (SRAM).

Storage 414 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 414 may include technology to increase the storage performance enhanced protection for valuable digital media when multiple hard drives are included, for example.

Graphics subsystem 415 may perform processing of images such as still or video for display. Graphics subsystem 415 may be a graphics processing unit (GPU) or a visual processing unit (VPU), for example. An analog or digital interface may be used to communicatively couple graphics subsystem 415 and display 420. For example, the interface may be any of a High-Definition Multimedia Interface, DisplayPort, wireless HDMI, and/or wireless HD compliant techniques. Graphics subsystem 415 may be integrated into processor 410 or chipset 405. In some implementations, graphics subsystem 415 may be a stand-alone card communicatively coupled to chipset 405.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 418 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 418 may operate in accordance with one or more applicable standards in any version.

In various implementations, display 420 may include any television type monitor or display. Display 420 may include, for example, a computer display screen, touch screen display, video monitor, television-like device, and/or a television. Display 420 may be digital and/or analog. In various implementations, display 420 may be a holographic display. Also, display 420 may be a transparent surface that may receive a visual projection. Such projections may convey various forms of information, images, and/or objects. For example, such projections may be a visual overlay for a mobile augmented reality (MAR) application. Under the control of one or more software applications 416, platform 402 may display user interface 422 on display 420.

In various implementations, content services device(s) 430 may be hosted by any national, international and/or independent service and thus accessible to platform 402 via the Internet, for example. Content services device(s) 430 may be coupled to platform 402 and/or to display 420. Platform 402 and/or content services device(s) 430 may be coupled to a network 460 to communicate (e.g., send and/or receive) media information to and from network 460. Content delivery device(s) 440 also may be coupled to platform 402 and/or to display 420.

In various implementations, content services device(s) 430 may include a cable television box, personal computer, network, telephone, Internet enabled devices or appliance capable of delivering digital information and/or content, and any other similar device capable of unidirectionally or bidirectionally communicating content between content providers and platform 402 and/display 420, via network 460 or directly. It will be appreciated that the content may be communicated unidirectionally and/or bidirectionally to and from any one of the components in system 400 and a content provider via network 460. Examples of content may include any media information including, for example, video, music, medical and gaming information, and so forth.

Content services device(s) 430 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 402 may receive control signals from navigation controller 450 having one or more navigation features. The navigation features of controller 450 may be used to interact with user interface 422, for example. In embodiments, navigation controller 450 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 450 may be replicated on a display (e.g., display 420) by movements of a pointer, cursor, focus ring, or other visual indicators displayed on the display. For example, under the control of software applications 416, the navigation features located on navigation controller 450 may be mapped to virtual navigation features displayed on user interface 422, for example. In embodiments, controller 450 may not be a separate component but may be integrated into platform 402 and/or display 420. The present disclosure, however, is not limited to the elements or in the context shown or described herein.

In various implementations, drivers (not shown) may include technology to enable users to instantly turn on and off platform 402 like a television with the touch of a button after initial boot-up, when enabled, for example. Program logic may allow platform 402 to stream content to media adaptors or other content services device(s) 430 or content delivery device(s) 440 even when the platform is turned “off” In addition, chipset 405 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 400 may be integrated. For example, platform 402 and content services device(s) 430 may be integrated, or platform 402 and content delivery device(s) 440 may be integrated, or platform 402, content services device(s) 430, and content delivery device(s) 440 may be integrated, for example. In various embodiments, platform 402 and display 420 may be an integrated unit. Display 420 and content service device(s) 430 may be integrated, or display 420 and content delivery device(s) 440 may be integrated, for example. These examples are not meant to limit the present disclosure.

In various embodiments, system 400 may be implemented as a wireless system, a wired system, or a combination of both. When implemented as a wireless system, system 400 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 400 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 402 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 4.

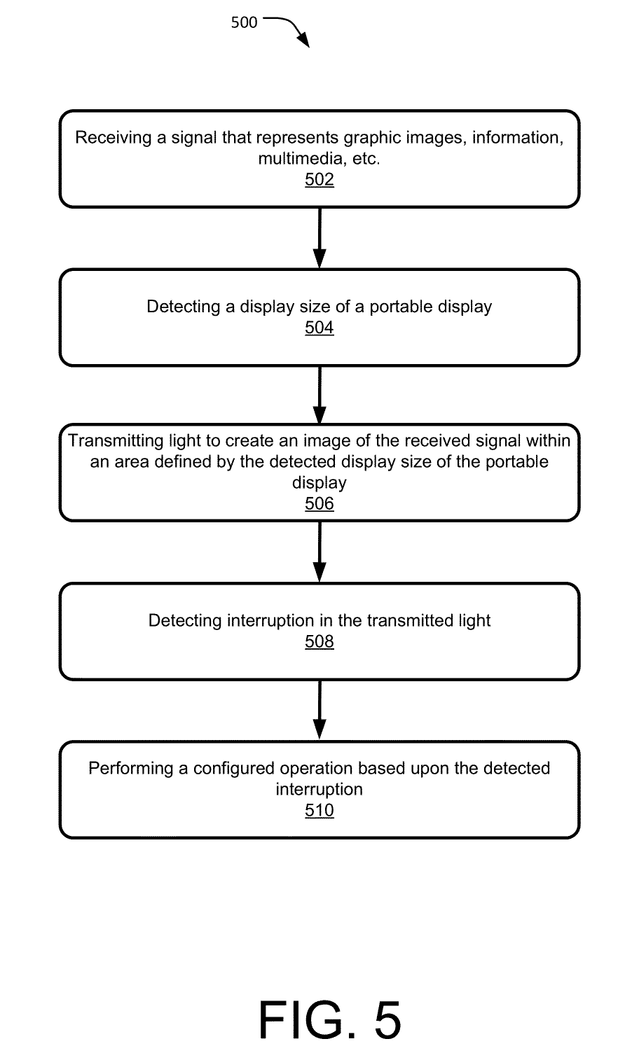

FIG. 5 shows an example process flowchart 500 illustrating an example method of implementing wearable projector to display images in a portable display. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 502, receiving a signal that represents images, information, multimedia, etc. is performed. In an implementation, I/O component (e.g., I/O component 302) or a transceiver (e.g., transceiver component 304) receives the images, information, multimedia, etc. from wired input peripherals, a network, or through radio signals. For example, the images, information, multimedia, etc. are received through the Internet, Wi-Fi signals, cellular signals, Bluetooth™ signals, or NFC signals.

At block 504, detecting a display size of a portable display is performed. In an implementation, an image sensor (e.g., image sensor 306) is configured to detect the display size or perimeter of a surface in the portable display (e.g., portable display 110). For example, an infra-red signal may be generated and utilized by the image sensor 306 to determine if the portable display 110 is folded for smaller viewing of the images, information, multimedia, etc. In another example, the image sensor 306 determines range of the portable display 110 from the wearable projector 104 based upon infra-red signal reflections.

At block 506, transmitting light to create an image of the received signal within an area defined by the detected display size of the portable display is performed. In an implementation, a beam projector (e.g., beam projector 312) is configured to transmit light in order to project the images, information, multimedia, etc. in the portable display 110. In this implementation, the focus of the transmitted light may be adjusted through the iServer 308 based upon the detected distance of the wearable projector 104 from the portable display 110, or based upon the detected display size of the portable display 110.

At block 508, detecting interruption in a transmitted light during the projecting of the images, information, multimedia, etc. is performed. In an implementation, the image sensor 306 is configured to detect interruption in the transmitted light during the projecting of the images, information, multimedia, etc. For example, a pointing of a finger by a user (e.g., teenager 102) at the image in the portable display 110 creates changes in the reflected infra-red signal that is used to detect movements within the detected display size of the portable display 110.

At block 510, performing a configured operation based upon the detected interruption is performed. In an implementation, the iServer 308 is configured to perform an operation based upon the detected movements within the display size of the portable display 110. For example, the pointing of the finger is configured to stop or pause the projecting of the images, information, multimedia, etc. In another example, the pointing of the finger aligns the projecting of the images, information, multimedia, etc. to the direction of the finger.

What is claimed is:

1. A wearable projector device comprising:
a transceiver component that is configured to receive signals;
an image sensor that is configured to detect a display size of a portable display;
a beam projector that is configured to transmit light within the detected size of the portable display to create an image of the received signal; and
a server component configured to control the transmission of light based upon the detected size of the portable display, wherein the server component dynamically adjusts operation of the wearable projector device based upon interruption of the transmitted light at the portable display.

2. The wearable projector device as recited in claim 1, wherein the transceiver component receives the signal through a network, a wireless fidelity (Wi-Fi) signal, a Bluetooth™ signal, a cellular signal, or a near field communications (NFC) signal.

3. The wearable projector device as recited in claim 1, wherein the signal includes information and/or multimedia.

4. The wearable projector device as recited in claim 1, wherein the image sensor generates infra-red signals to detect interruption of the transmitted light, the interruption includes changes in infra-red signal reflections due to physical movements within the detected display size of the portable display.

5. The wearable projector device as recited in claim 1, wherein multiple image sensors are employed to provide dual image sensors parallaxing.

6. The wearable projector device as recited in claim 1, wherein the portable display includes a screen of a wireless device.

7. The wearable projector device as recited in claim 1, wherein the beam projector is configured to transmit light within the detected size of the portable display that includes a plastic flexible display with array of concave dimples.

8. The wearable projector device as recited in claim 1, wherein the server component performs wireless communications with a wireless device through the transceiver component.

9. The wearable projector device as recited in claim 1 further comprising a photovoltaic cells to generate power in the wearable projector, wherein the photovoltaic cells includes solar cells or chargeable cells that are used when the wearable projector device is turned off

10. A system comprising:
a wireless device;
a portable display; and
a wearable projector configured to establish wireless communication with the wireless device, the wearable projector comprising:
a transceiver component that is configured to receive multimedia signal from the wireless device;
an image sensor that is configured to detect a display size of the portable display;
a beam projector that is configured to transmit light within the detected size of the portable display to create an image of the received multimedia signal; anad
a server component configured as system on chip (SOC) microprocessor to control operations of the wearable projector based upon interruption of transmitted light at the portable display or based upon the detected size of the portable display.

11. The system as recited in claim 10, wherein the wireless device is configured to transmit the multimedia signal to the wearable projector.

12. The system as recited in claim 10, wherein the wearable projector receives the multimedia signal from the wireless device through a network, a wireless fidelity (Wi-Fi) signal, a Bluetooth™ signal, a cellular signal, or a near field communications (NFC) signal.

13. The system as recited in claim 10, wherein the image sensor generates infra-red signals to detect interruption of the transmitted light, the interruption includes changes in infra-red signal reflections due to physical pointing of a human hand or finger within the detected display size of the portable display.

14. The system as recited in claim 10, wherein multiple image sensors are employed to provide dual image sensors parallaxing.

15. The system as recited in claim 10, wherein the portable display includes a screen of the wireless device, a flexible transparent plastic or glass, or a piece of paper.

16. The system as recited in claim 10, wherein the beam projector is configured to transmit light within the detected size of the portable display that includes a plastic flexible display with array of concave dimples.

17. The system as recited in claim 10, wherein the server component performs wireless communications with the wireless device through the transceiver component.

18. The system as recited in claim 10 further comprising a photovoltaic cells to generate power in the wearable projector, wherein the photovoltaic cells includes solar cells or chargeable cells that are used when the wearable projector device is turned off

19. A method of implementing a wireless wearable projector, the method comprising:
receiving a signal;
detecting a display size of a portable display;
transmitting light within an area defined by the detected size of the portable display, the transmitted light is configured to create an image of the received signal;
detecting an interruption in the transmitted light; and
performing a configured operation based upon the detected interruption, wherein the interruption includes changes in infra-red signal reflections due to physical pointing of a human hand or finger within the detected display size of the portable display.

20. The method as recited in claim 19, wherein the receiving of the signal utilizes a network, a wireless fidelity (Wi-Fi) signal, a Bluetooth™ signal, a cellular signal, or a near field communications (NFC) signal.

21. The method as recited in claim 19, wherein the signal includes information and/or multimedia.

22. The method as recited in claim 19, wherein the detecting of the display size employs multiple image sensors to provide dual image sensors parallaxing.

23. The method as recited in claim 19, wherein the performing of a configured operation includes focus adjustment of the transmitted light to the portable display, or stopping of operation in the wireless wearable projector.
